(19) United States
(12) Patent Application Publication
(10) Pub. No.: US 2016/0084002 A1
(43) Pub. Date: Mar. 24, 2016

(54) LADDER SUPPORT TRAY

(71) Applicant: Ronald Leo EISLER, Calgary (CA)

(72) Inventor: Ronald Leo EISLER, Calgary (CA)

(21) Appl. No.: 14/495,185

(22) Filed: Sep. 24, 2014

(51) Int. Cl. E06C 7/16

(52) U.S. Cl. CPC E06C 7/16

(57) ABSTRACT

An apparatus for supporting articles from a ladder comprises a horizontal tray member having a top and a bottom surfaces extending between front and rear edges and at least two inverted hooks secured to the rear edge of the tray member wherein each of the inverted hooks are sized to be selectably attachable to a first horizontal ladder member. The apparatus further comprises a pair of support legs extending from the horizontal tray member, each support leg including a foot at a distal end thereof to engage a support surface. A kit may also be provide comprising the tray and at least one extension bar receivable within a bore of a ladder rung so as to extend to a side thereof.

### BACKGROUND OF THE INVENTION

1. Field of Invention

The present invention relates to support trays. More specifically, the present invention relates to multi-function adjustable support trays to be attachable to an extension ladder, stepladder, stool ladder and the like.

2. Description of Related Art

When working from a sloped roof or on a ladder, it is useful to have a stable horizontal surface to place any sort of work materials and/or tools in a position where they can be retrieved and replaced to allow the worker the free use of both hands while working. Traditionally, support trays are used to meet this need and they can be integrally attached to or are securable to a ladder and the like. Such ladder trays or article holders can be found in the prior art.

For example, U.S. Pat. No. 4,261,435 to Winter discloses a tray with a clip and wire frame for support for secure mounting to the top of a step ladder. The tray is shaped to hold tools and has small pockets for containment of small items. Use of this tray is limited as the support legs disclosed are not adjustable in length.

U.S. Pat. No. 5.052,581 to Christ et al. discloses a ladder-supported holding tray providing engagement to a ladder rung. However, use of this tray is also limited as the bottom support clamp is hinged to the support bar thereby enabling the clamp to be rotated about the ladder rung which will be unsuitable for use with round ladder rungs. Additionally, the top hooks of Christ et al. Are oriented toward the front of the tray such that horizontal motion or force applied to the tray may be successful in dislodging the tray from the ladder.

Further, the designs disclosed in the prior art often fail in practical usage due to mounting difficulty as designs are often targeted for one specific ladder type, size or manufacturer. Many lack the ability of quick and easy adjustability for four way leveling, interfere with the tray attachment points with ladder components, have poor tray access and are inadequate with regard to stability.

### SUMMARY OF THE INVENTION

The present invention is simple and works on almost all ladder types and does not get in the way of the user. Further, the present invention is quick to setup as it does not require locking knobs or other components to attach and move or remove from ladder.

According to a first embodiment of the present invention there is disclosed an apparatus for supporting articles from a ladder comprising a horizontal tray member having a top and a bottom surfaces extending between front and rear edges and at least two inverted hooks secured to the rear edge of the tray member wherein each of the inverted hooks are sized to be selectably attachable to a first horizontal ladder member. The apparatus further comprises a pair of support legs extending from the horizontal tray member, each support leg including a foot at a distal end thereof to engage a support surface.

The inverted hooks may be adapted to engage a step of a ladder. The inverted hooks may be adapted to engage an extension rod extending from a step of a ladder. The inverted hooks may have a u-shaped profile.

The horizontal tray may include apertures therethrough for securing tools. The horizontal tray may include hooks extending therefrom for securing tools. The bottom surface of the horizontal tray member may be rubber coated.

Each of the support legs may have an adjustable length. Each of the feet may include a u-shaped opening oriented in line with the support leg. The support legs may be rotatably supportable about a rod secured to the tray member.

According to a further embodiment of the present invention there is disclosed a kit for supporting articles from a ladder comprising at least one extension bar receivable within a bore of a ladder rung so as to extend to a side thereof and an article supporting apparatus. The article supporting apparatus comprises a horizontal tray member having a top and a bottom surfaces extending between front and rear edges and at least two inverted hooks secured to the rear edge of the tray member wherein each of the inverted hooks are sized to be selectably attachable to the extension bar. The article supporting apparatus further comprises a pair of support legs extending from the horizontal tray member, each support leg including a foot at a distal end thereof to engage a support surface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a ladder having an apparatus for supporting objects therefrom according to a first embodiment of the present invention attached thereto.

FIG. 2 is a perspective view of the apparatus for supporting objects from a ladder of FIG. 1.

FIG. 3 is a side view of the apparatus of FIG. 2.

FIG. 4 is a front view of the apparatus of FIG. 2.

FIG. 5 is a detailed exploded perspective view of a rung extender for use with the apparatus of FIG. 2 being inserted into the bore of a ladder rung.

FIG. 6 is a front view of the apparatus of FIG. 2 and the rung extender of FIG. 3 applied to a ladder.

FIG. 7 is a detailed perspective view of one of the feet of the apparatus of FIG. 2.

FIG. 8 is a perspective view of an apparatus for supporting articles from a ladder having a cover according to a further embodiment of the present invention.

FIG. 9 is a cross sectional view of the cover of FIG. 8.

### DETAILED DESCRIPTION

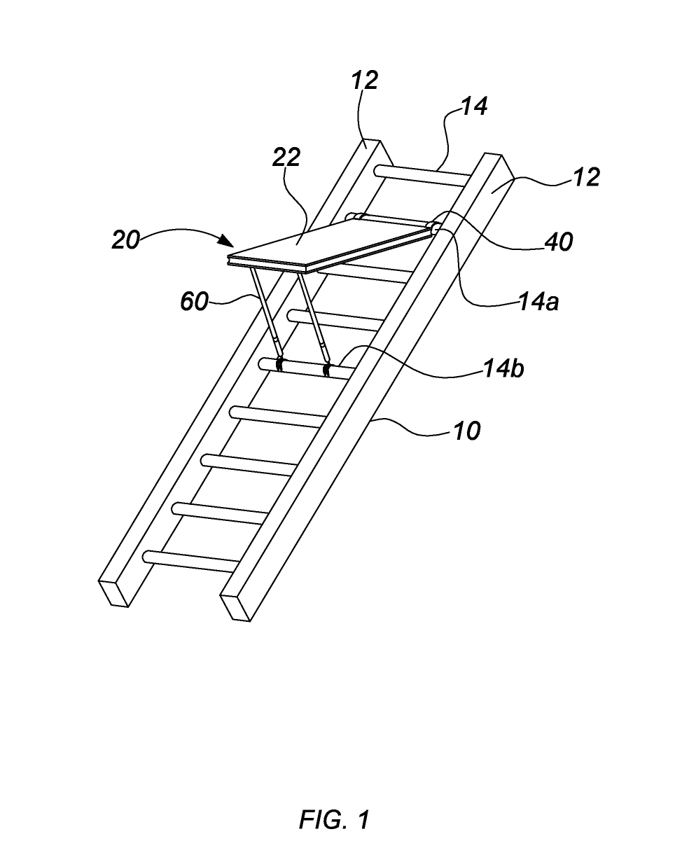

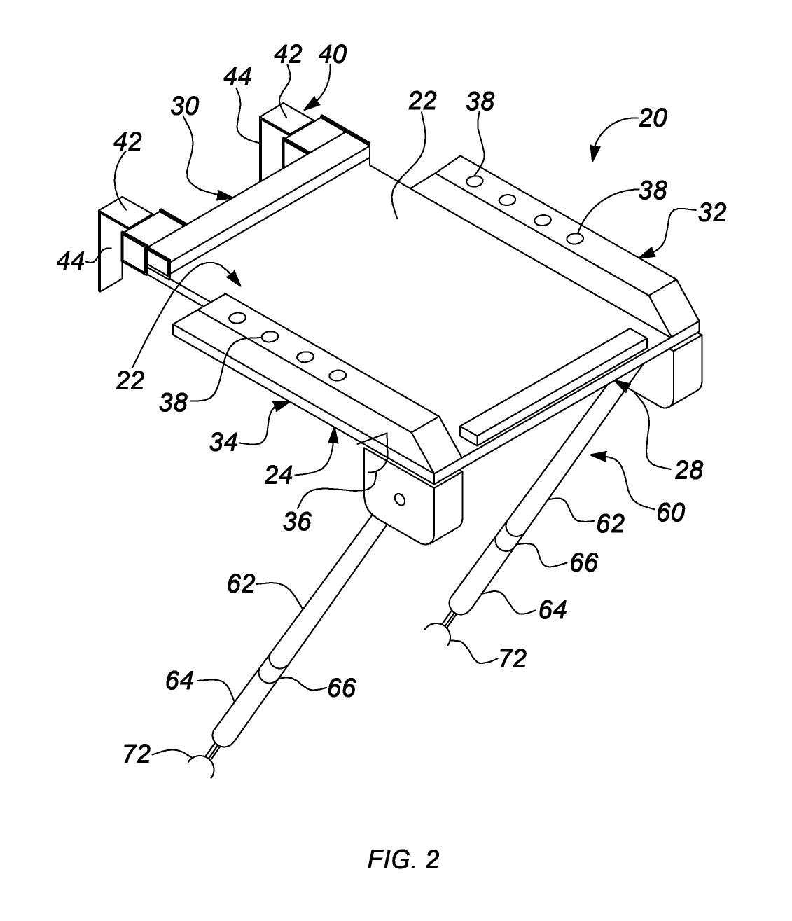

Referring to FIGS. 1 through 4, an apparatus for supporting articles from a ladder 10 according to a first embodiment of the invention is shown generally at 20. The ladder 10 may be formed by side members 12 with a plurality of rungs or steps 14 therebetween as are commonly known. The apparatus 20 is connectable to one or more rungs of the ladder to support articles thereon as desired by a user. The apparatus 20 comprises a tray member 22, having at least two inverted hooks 40 and a pair of support legs 60 extending therefrom.

The horizontal tray member generally shown as 22 comprises a substantially planar member having top and bottom surfaces 24 and 26, respectively and extending between front and rear ends, 28 and 30, respectively and first and second side edges 32 and 34, respectively. The tray member 22 may have a substantially rectangular outline as illustrated or may optionally have other shapes as will be appreciated. The top surface 24 may include embedded magnets to prevent metallic objects from slipping off. Optionally, the bottom surface 26 may include a rubber or other suitable slip reducing covering to prevent slipping of the tray. Optionally, one or both of the first and second side edges 32 and 34 may include hooks 36 or apertures 38 therethrough operable to secure tools other articles thereto. It will also be appreciated that a variety of apertures, hooks and other suitable securing structures may be provided in the top surface, edges or through the tray member itself, such as, by way of non-limiting example, slots for holding radios, cup holders, cell phone pockets and or clips, cigarette trays, The tray member 22 may be sized to have a top surface 24 adapted to receive conventional articles for use on ladders, such as by way of non-limiting example, paint trays or the like.

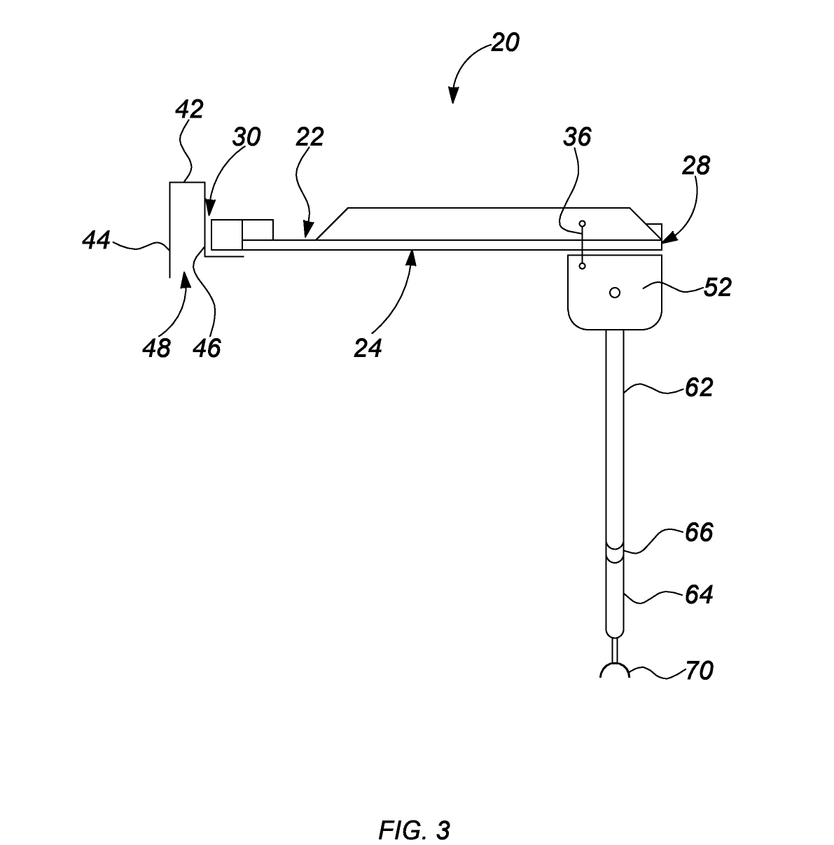

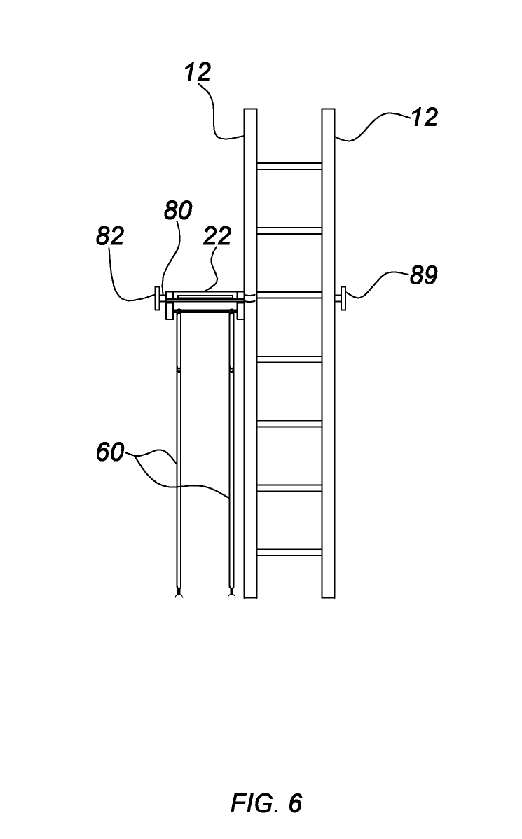

The inverted hooks 40 are secured to and extend from the rear edge 36 of the tray member 22 and are formed of front and rear upright members, 46 and 44, respectively with a top member 42 therebetween. As illustrated in FIG. 3, the inverted hooks 40 form an inverted u-shaped member having an opening 48 oriented in a downward direction. The inverted hooks 40 are sized to receive a rung 14 of a ladder 10 therein and may also be sized to receive the top step of a step ladder. As illustrated in FIG. 6, the inverted hooks may also be sized to receive therein an extension rod extending from a ladder rung as will be more fully described below.

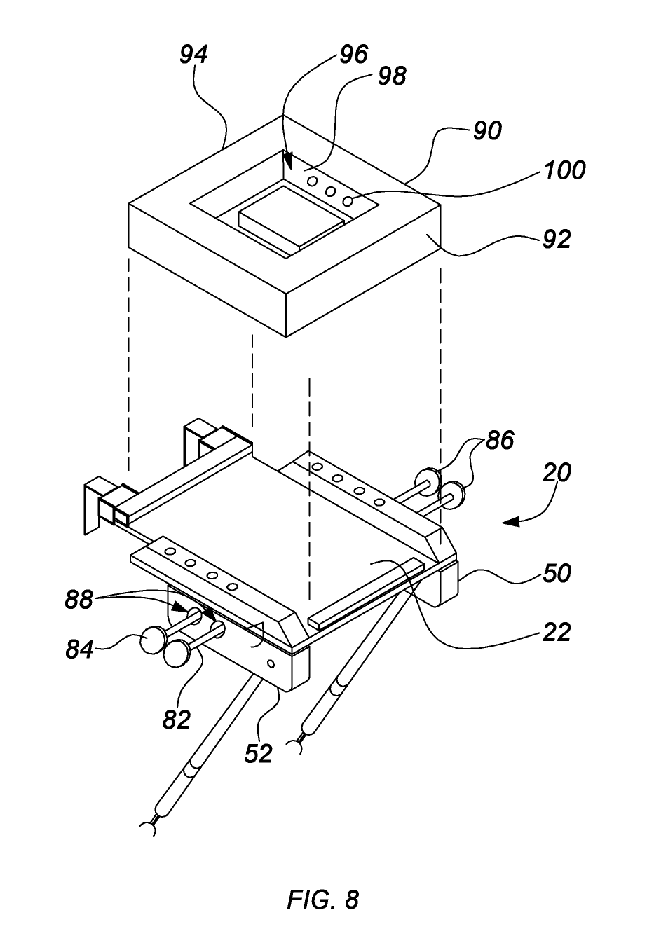

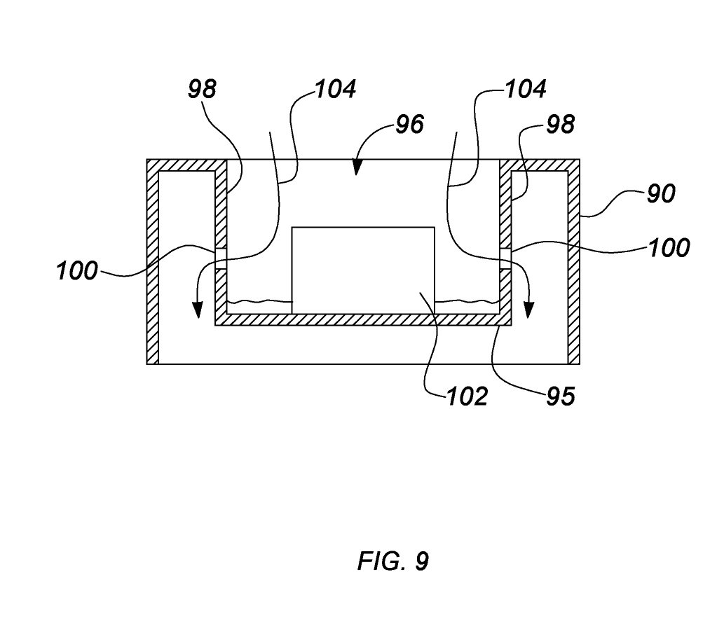

Optionally as illustrated in FIGS. 8 and 9, the apparatus may include a cover 90 sized to extend over the tray member 22. The cover 90 extends between front and rear edges 92 and 94, respectively and includes a recessed tray 96 therein. The recessed tray 96 has a solid bottom 95 and side walls 98 wherein the side walls 98 may include a plurality of bores 100 therethrough adapted to permit airflow and humidity to pass therethrough. As illustrated in FIG. 9, the recessed tray 96 is adapted to receive a wetted sponge 102 or the like such that airflow through the bores 100 which is generally indicated at 104 will be humidified thereby providing humidity to space between the tray 22 and the cover 90 to prevent drying of paint brushes and the like. As illustrated in FIG. 8, the bores may be located only proximate to the front 92 of the cover to prevent water from running into the paint when the cover and tray are tipped up.

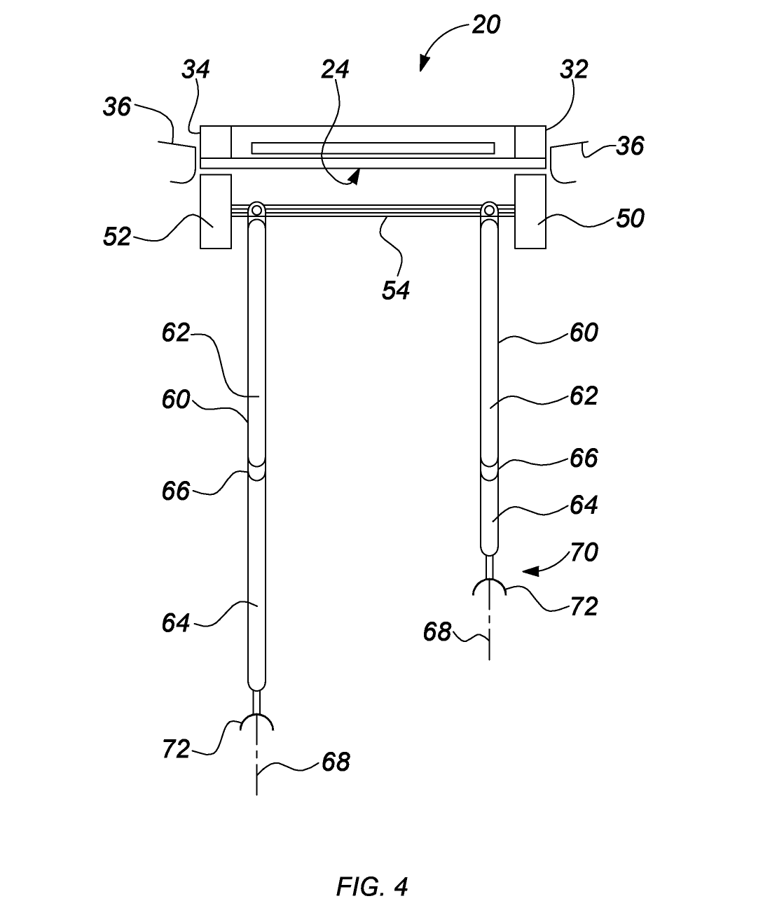

Located proximate to the front edge 28 of the tray member 22 are first and second side blocks 50 and 52, respectively. As illustrated in FIG. 4, the first and second side blocks 50 and 52 includes a rod 54 extending therebetween. The support legs 60 are rotatably supported by the rod 54 so as to have an adjustable angle relative to the tray member 22. It will also be appreciated that the support legs may be folded to a position parallel to the tray member for storage and transportation.

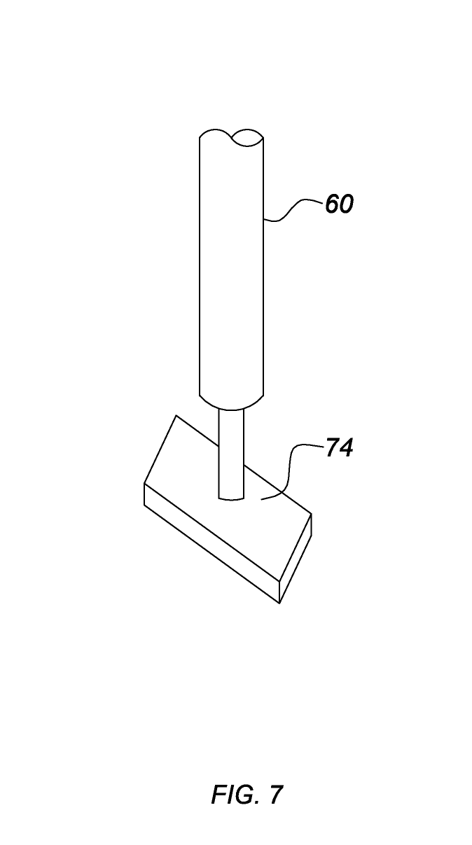

Each support leg 60 comprises a telescoping member formed of first and second elongate members 62 and 64, respectively having a selectably locking means 66 therebetween as are commonly known. A foot 70 is located at the distal end of each support leg 60 comprising a u-shaped member 72. The u-shaped member 72 may be sized and shaped to engage a rung of a ladder or may optionally be adapted to be engagable upon a ground surface as illustrated in FIG. 6. The foot 70 may be rotatable about an axis 68 of the support leg 60 however the u-shaped member will be maintained along the axis 68 so as to prevent the u-shaped member from rotating about a ladder-rung which may result in the foot slipping off the rung. Optionally as illustrated in FIG. 7, the feet 70 may be formed of substantially planar members 74 having a rotatable connection to the support leg. The planar members 74 may be rubber coated to reduce slipping or include embedded magnets for use on metallic floors.

As illustrated in FIG. 1, in operation, the inverted hooks 40 of the apparatus may be secured over a first rung 14a of a ladder. Thereafter the support legs 60 may be independently adjusted to a desired length and secured onto a second rung 14b of the ladder to support the tray member 22 in a substantially horizontal orientation. Although the apparatus is illustrated as extending from the front side of a ladder in the attached figures, it will also be appreciated that it may be extended from the rear surface as well.

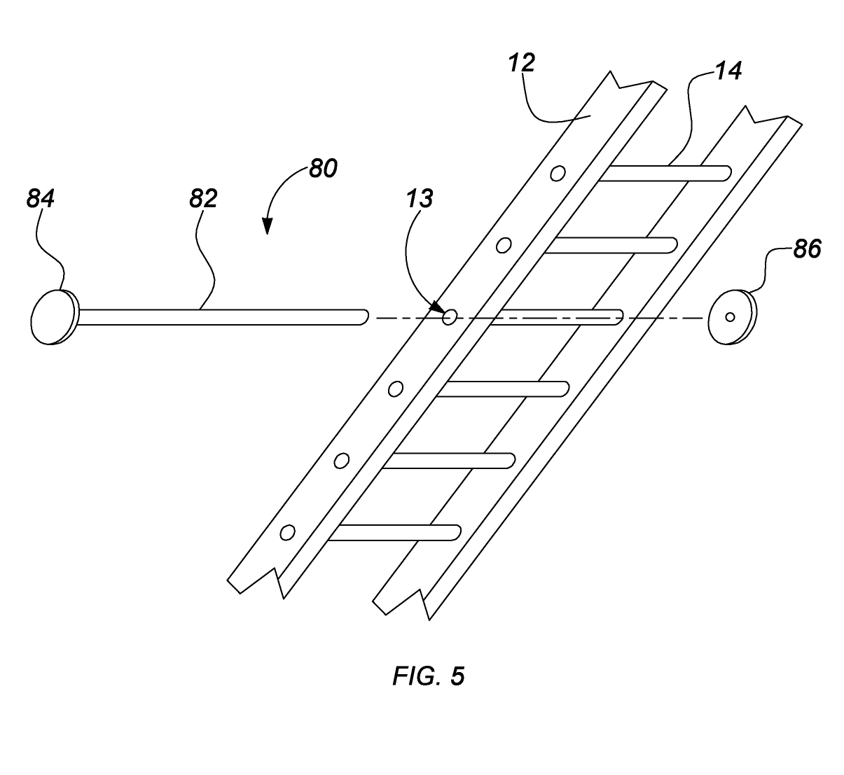

Turning now to FIGS. 5 and 6, an optional extension member 80 may be provided which is adapted to provide an extended surface to secure the apparatus 20 to the side of a ladder 10. The extension member 80 comprises an elongate rod 82 sized to be received within a bore 13 through a ladder rung 14. The elongate rod 82 includes a first end plate 84 on one end thereof and a selectably connectable second end plate 86 on the other end thereof. The second end plate 86 may be securable to the extension member by any known means, such as connectors, threading or the like. The extension member 80 has a length selected to exceed the width of the ladder 10 by a distance sufficient to extend the extension member 80 from the side thereof sufficient to provide a mounting surface for the inverted hooks 40 of the present apparatus. As illustrated in FIG. 6, the inverted hooks 40 of the apparatus may be secured over the extension member 80 to locate the tray member to the side of the ladder. Thereafter the support legs 60 may be extended to the ground surface or optionally to a second extension member located through a second rung below the first. As illustrated in FIG. 8, the elongate rods 82 may be passed through bores 88 in the first and second side blocks 50 and 52.

While specific embodiments of the invention have been described and illustrated, such embodiments should be considered illustrative of the invention only and not as limiting the invention as construed in accordance with the accompanying claims.

1. An apparatus for supporting articles from a ladder comprising:
a horizontal tray member having a top and a bottom surfaces extending between front and rear edges and first and second side edges having a raised portion proximate to each of said front and rear edges and first and second side edges;
at least two inverted hooks secured to said rear edge of said tray member wherein each of said inverted hooks are sized to be selectably attachable to a first horizontal ladder member; and
a pair of support legs extending from said horizontal tray member, each support leg including a foot at a distal end thereof to engage a support surface.

2. The apparatus of claim 1, wherein said inverted hooks are adapted to engage a step of a ladder.

3. The apparatus of claim 1, wherein said inverted hooks are adapted to engage an extension rod extending from a step of a ladder.

4. The apparatus of claim 1, wherein said inverted hooks have a u-shaped profile.

5. The apparatus of claim 1, wherein said horizontal tray includes apertures therethrough for securing tools.

6. The apparatus of claim 1, wherein said horizontal tray includes hooks extending therefrom for securing tools.

7. The apparatus of claim 1, wherein said bottom surface of said horizontal tray member is rubber coated.

8. The apparatus of claim 1, wherein each of said support legs have an adjustable length.

9. The apparatus of claim 1, wherein each of said feet includes a u-shaped opening oriented in line with said support leg.

10. The apparatus of claim 1, wherein said support legs are rotatably supportable about a rod secured to said tray member.

11. A kit for supporting articles from a ladder comprising:
at least one extension bar receivable within a bore of a ladder rung so as to extend to a side thereof; and
an article supporting apparatus comprising:
a horizontal tray member having a top and a bottom surfaces extending between front and rear edges;
at least two inverted hooks secured to said rear edge of said tray member wherein each of said inverted hooks are sized to be selectably attachable to said extension bar; and
a pair of support legs extending from said horizontal tray member, each support leg including a foot at a distal end thereof to engage a support surface.
